(19) United States
(12) Patent Application Publication
(10) Pub. No.: US 2025/0026108 A1
(43) Pub. Date: Jan. 23, 2025

(54) PROTECTIVE FILM MODULE AND METHOD OF MANUFACTURING THE SAME

(71) Applicant: Samsung Display Co., LTD., Yongin-si (KR)

(72) Inventor: DONG-SU YEE, Yongin-si (KR)

(21) Appl. No.: 18/749,707

(22) Filed: Jun. 21, 2024

(30) Foreign Application Priority Data
Jul. 21, 2023 (KR) 10-2023-0095020

(51) Int. Cl. B32B 17/10; B32B 3/26; B32B 3/30

(52) U.S. Cl. CPC B32B 17/10; B32B 3/266; B32B 3/30; B32B 2250/03; B32B 2307/7376; B32B 2315/08; B32B 2333/12; B32B 2371/00; B32B 2379/08

(57) ABSTRACT

A protective film module includes a first film, a second film disposed on the first film, and a thin film layer disposed between the first film and the second film. The first film includes a first hook portion that does not overlap the thin film layer in a plan view, the second film includes a second hook portion that does not overlap the thin film layer in the plan view, and at least a portion of the first hook portion is disposed on the second hook portion.

This application claims priority to Korean Patent Application No. 10-2023-0095020, filed on Jul. 21, 2023, and all the benefits accruing therefrom under 35 U.S.C. § 119, the content of which in its entirety is herein incorporated by reference.

### BACKGROUND

### 1. Field of Disclosure

The present disclosure relates to a protective film module and a method of manufacturing the same. More particularly, the present disclosure relates to a protective film module including a plurality of films that protects a thin glass and a method of manufacturing the protective film module.

### 2. Description of the Related Art

Various display devices that are applied to a multimedia device, such as a television set, a mobile phone, a tablet computer, a navigation unit, a game unit, etc., are being developed. In recent years, a foldable or rollable display device that includes a flexible display member is being developed to improve portability and user convenience.

An ultra-thin glass (“UTG”) is applied to the foldable or rollable display device to facilitate the display device to be folded or rolled. The UTG is very thin, with a thickness of less than 100 micrometers (μm), so that the UTG has not only a flexibility to be smoothly folded but also a scratch resistance property of a glass material.

### SUMMARY

The present disclosure provides a protective film module that prevents foreign substances from entering a side portion of a thin glass without using an adhesive in distribution or handling of the thin glass.

The present disclosure provides a method of manufacturing the protective film module that protects the thin glass.

Embodiments of the invention provide a protective film module including: a first film, a second film disposed on the first film, and a thin film layer disposed between the first film and the second film. The first film includes a first hook portion, which is spaced apart from the thin film layer in a plan view, the second film includes a second hook portion, which is spaced apart from the thin film layer in the plan view, and at least a portion of the first hook portion is disposed on the second hook portion.

Each of the first film and the second film may have a size greater than a size of the thin film layer in the plan view.

The first film may have the same size as the second film in the plan view.

The thin film layer may be disposed directly on the first film, and the second film may be disposed directly on the thin film layer.

Each of the first film and the second film may have a thickness equal to or greater than about 100 micrometers and equal to or smaller than about 200 micrometers.

The thin film layer may include a glass material.

Each of the first film and the second film may include polyethylene terephthalate, polyimide, or polymethyl methacrylate.

The first film may be provided with a plurality of holes defined therethrough, overlapping the thin film layer in the plan view, and spaced apart from each other.

Each of the holes may have a diameter equal to or greater than about 3 millimeters (mm) and equal to or smaller than about 5 mm.

A distance between two holes adjacent to each other among the holes may be equal to or greater than about 3 mm and equal to or smaller than about 5 mm.

Each of the first film and the second film may have a rectangular shape, the first film may include a first-first film side parallel to a first direction, a first-second film side parallel to the first direction and opposite to the first-first film side, a first-third film side parallel to a second direction intersecting the first direction, and a first-fourth film side parallel to the second direction and opposite to the first-third film side, the second film may include a second-first film side parallel to the first direction, a second-second film side parallel to the first direction and opposite to the second-first film side, a second-third film side parallel to the second direction, and a second-fourth film side parallel to the second direction and opposite to the second-third film side, a length in the first direction of the first-first film side may be greater than a length in the second direction of the first-third film side, and a length in the first direction of the second-first film side may be greater than a length in the second direction of the second-third film side.

The thin film layer may include a first thin film side parallel to the first-first film side, a second thin film side parallel to the first-second film side, a third thin film side parallel to the first-third film side, and a fourth thin film side parallel to the first-fourth film side, the first film may further include a first-first film portion adjacent to the first thin film side, a first-second film portion adjacent to the second thin film side, a first-third film portion adjacent to the third thin film side, a first-fourth film portion adjacent to the fourth thin film side, and a first thin film cover portion overlapping and corresponding to the thin film layer in the plan view, the second film may further include a second-first film portion including the second-first film side, a second-second film portion including the second-second film side, a second-third film portion including the second-third film side, a second-fourth film portion including the second-fourth film side, and a second thin film cover portion overlapping and corresponding to the thin film layer in the plan view, and the first hook portion may be disposed in at least one of the first-first film portion, the first-second film portion, the first-third film portion, and the first-fourth film portion.

Each of the first hook portion and the second hook portion may be provided in plural, and the first hook portions may be disposed in the first-first film portion, the first-second film portion, the first-third film portion, and the first-fourth film portion, respectively.

Each of the first hook portion and the second hook portion may be provided in plural, and the first hook portions may be disposed in the first-first film portion and the first-second film portion and may not disposed in the first-third film portion and the first-fourth film portion.

The first-first film portion may include a first-first contact portion, which does not overlap the first hook portion in the plan view, the second-first film portion may include a second-first contact portion, which does not overlap the second hook portion in the plan view, and at least a portion of the first-first contact portion may be in contact with the second-first contact portion.

Each of the first hook portion and the second hook portion may have a rectangular shape, the first hook portion may include a first-first hook side extending in the first direction, a first-second hook side opposite to the first-first hook side and extending in the first direction, a first-third hook side extending in the second direction intersecting the first direction, and a first-fourth hook side opposite to the first-third hook side and extending in the second direction, the second hook portion may include a second-first hook side extending in the first direction, a second-second hook side opposite to the second-first hook side and extending in the first direction, a second-third hook side extending in the second direction, and a second-fourth hook side opposite to the second-third hook side and extending in the second direction, the first-first hook side may have a length in the first direction greater than a length in the second direction of the first-third hook side, and the second-first hook side may have a length in the first direction greater than a length in the second direction of the second-third hook side.

Each of the length of the first-first hook side, a length in the first direction of the first-second hook side, the length of the second-first hook side, and a length in the second direction of the second-second hook side may be equal to or greater than about 5 mm and equal to or smaller than about 20 mm, and each of the length of the first-third hook side, a length in the first direction of the first-fourth hook side, the length of the second-third hook side, and a length in the second direction of the second-fourth hook side may be equal to or greater than about 3 mm and equal to or smaller than about 10 mm.

The first film may be provided with a first opening, which surrounds the first-first hook side, the first-second hook side, and the first-third hook side and be spaced apart from the thin film layer in the plan view, and the second film may be provided with a second opening, which surrounds the second-first hook side, the second-second hook side, and the second-fourth hook side and be spaced apart from the thin film layer in the plan view.

Embodiments of the invention provide a method of manufacturing a protective film module. The method includes providing a stage, providing a first film in which a first hook portion is formed and through which holes are formed and a second film in which a second hook portion is formed, placing the first film on the stage, placing a thin film layer on the first film not to overlap the first hook portion in a plan view and to overlap the holes in the plan view, placing the second film on the thin film layer, and placing at least a portion of the first hook portion on the second hook portion.

Each of the first hook portion and the second hook portion may be provided in plural.

According to the above, the first film and the second film of the protective film module are able to reduce a variation in surface energy of the thin film layer using the hook portions instead of using an adhesive.

According to the above, a pin is used to engage the first film and the second film in the method of manufacturing the protective film module, and thus, a difficulty in the manufacturing process is effectively improved.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a perspective view of a protective film module according to an embodiment of the present disclosure;

FIG. 2 is an exploded perspective view of a protective film module according to an embodiment of the present disclosure;

FIG. 3 is a cross-sectional view take along a line I-I′ of FIG. 1;

FIG. 4 is a cross-sectional view take along a line II-II′ of FIG. 1;

FIG. 5 is an exploded perspective view of some components of a protective film module according to an embodiment of the present disclosure;

FIG. 6 is an exploded perspective view of some components of a protective film module according to an embodiment of the present disclosure;

FIG. 7 is a flowchart illustrating a method of manufacturing a protective film module according to an embodiment of the present disclosure;

FIG. 8 is a perspective view illustrating a process of a method of manufacturing a protective film module according to an embodiment of the present disclosure;

FIG. 9 is a perspective view illustrating a process of a method of manufacturing a protective film module according to an embodiment of the present disclosure;

FIG. 10 is a perspective view illustrating a process of a method of manufacturing a protective film module according to an embodiment of the present disclosure; and

FIGS. 11A, 11B, and 11C are cross-sectional views illustrating a process of engaging a first film to a second film of a method of manufacturing a protective film module according to an embodiment of the present disclosure.

### DETAILED DESCRIPTION

In the present disclosure, it will be understood that when an element (or area, layer, or portion) is referred to as being “on”, “connected to” or “coupled to” another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms “first”, “second”, etc. may be used herein to describe various elements, these elements should not be limited by these terms. These terms are only used to distinguish one element from another element. Thus, a first element discussed below could be termed a second element without departing from the teachings of the present disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another elements or features as shown in the figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the present disclosure, a direction intersecting a first direction DR1 is referred to as a second direction DR2. A direction substantially perpendicular to a plane defined by the first and second directions DR1 and DR2 is referred to as a third direction DR3.

In the present disclosure, the expression “in a plan view” may mean a state of being viewed in the third direction DR3 (i.e., thickness direction of the protective film module).

Hereinafter, a protective film module PFM and a method of manufacturing the protective film module PFM according to embodiments of the present disclosure will be described with reference to accompanying drawings.

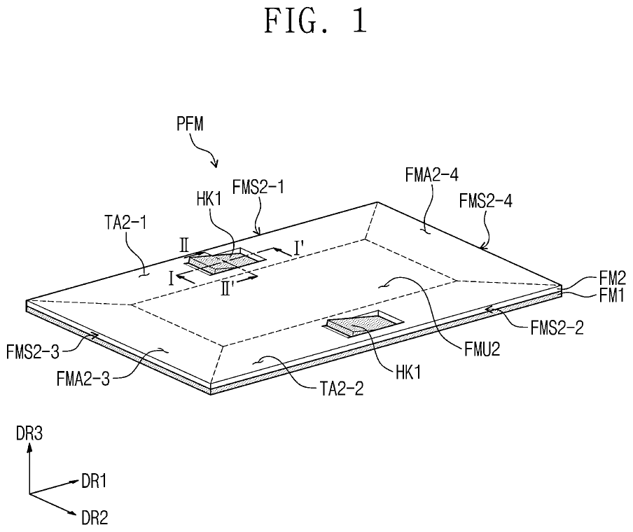

FIG. 1 is a perspective view of the protective film module PFM according to an embodiment of the present disclosure.

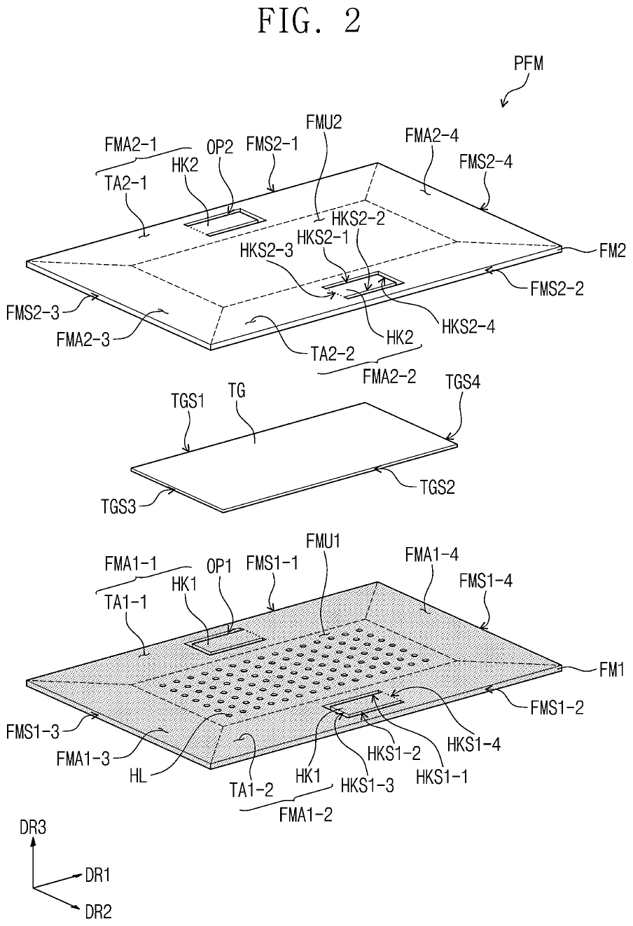

FIG. 2 is an exploded perspective view of the protective film module PFM according to an embodiment of the present disclosure.

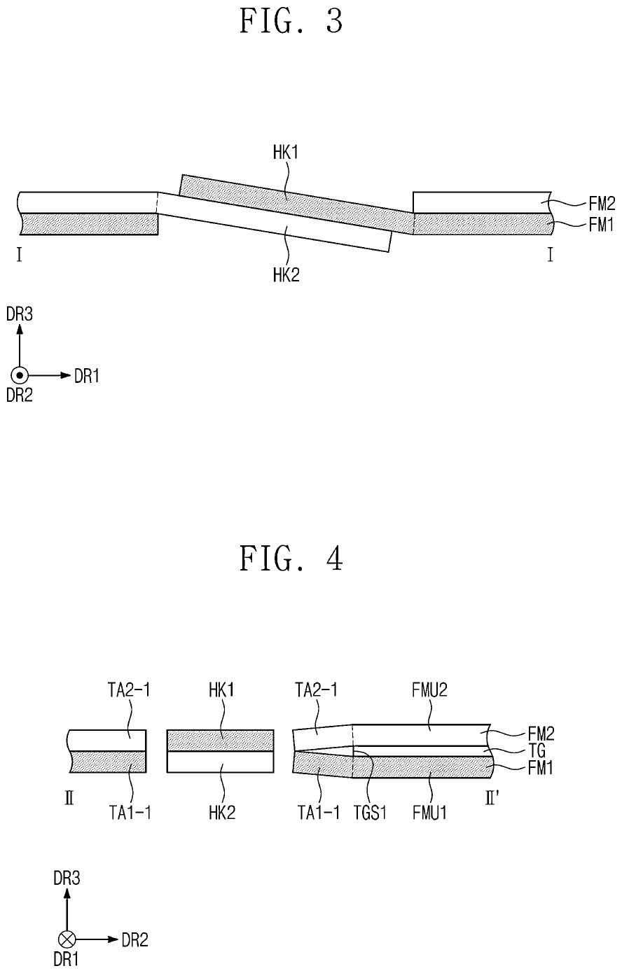

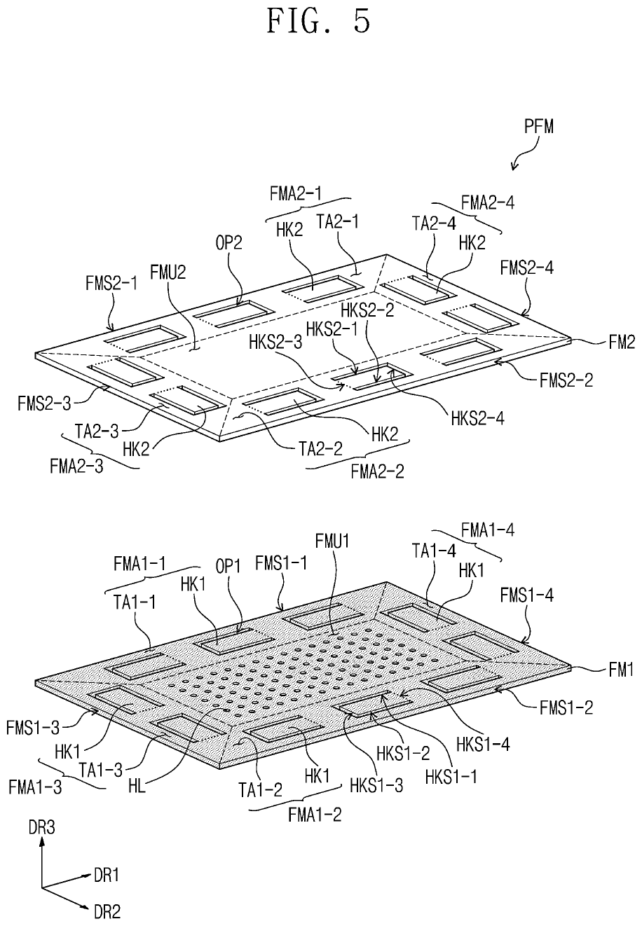

Referring to FIGS. 1 and 2, the protective film module PFM may include a first film FM1, a second film FM2, and a thin film layer TG disposed between the first film FM1 and the second film FM2. The first film FM1 may include a first hook portion HK1 that does not overlap the thin film layer TG in the plan view. The second film FM2 may include a second hook portion HK2 that does not overlap the thin film layer TG in the plan view. At least a portion of the first hook portion HK1 may be disposed on the second hook portion HK2. As at least the portion of the first hook portion HK1 is disposed on the second hook portion HK2, the first film FM1 may be in contact with a portion of the second film FM2 and may protect the thin film layer TG from foreign substances, and thus, a variation in surface energy (contact angle) of the thin film layer TG may be reduced. An arrangement relationship between the first hook portion HK1 and the second hook portion HK2 will be described in detail with reference to FIGS. 3 and 4.

According to the present embodiment, each of the first film FM1 and the second film FM2 may have a size greater than a size of the thin film layer TG. That is, when the hook portions HK1 and HK2 of the first film FM1 and the second film FM2 included in the protective film module PFM are connected to each other, the thin film layer TG may be covered by the first film FM1 and the second film FM2, and thus, the thin film layer TG may not be recognized by a naked eye. When the size of each of the first film FM1 and the second film FM2 is greater than the size of the thin film layer TG, a lower surface of the thin film layer TG may be covered by the first film FM1, and an upper surface of the thin film layer TG may be covered by the second film FM2. Accordingly, foreign substances may be prevented from being attached to the thin film layer TG. Thus, defects, such as a damage to a surface of the thin film layer TG or foreign substances entering the thin film layer TG, during storage and distribution of the thin film layer TG may be prevented.

According to an embodiment, the size of the first film FM1 and the size of the second film FM2 may be substantially the same as each other. That is, when the protective film module PFM is viewed in the plane (i.e., in a plan view), the first film FM1 may be covered by the second film FM2 and may not be recognized by the naked eye. In the case where the size of the first film FM1 and the size of the second film FM2 are substantially the same as each other, the first film FM1 and the second film FM2 may be manufactured through the same process. Thus, difficulty of production may be eased, and economic efficiency may be improved.

The thin film layer TG may be disposed directly on the first film FM1, and the second film FM2 may be disposed directly on the thin film layer TG. In the case where the thin film layer TG is disposed directly on the first film FM1 and the second film FM2 is disposed directly on the thin film layer TG, the lower surface of the thin film layer TG may be covered by the first film FM1, and the upper surface of the thin film layer TG may be covered by the second film FM2. Thus, foreign substances may be prevented from entering the thin film layer TG.

According to an embodiment, each of the first film FM1 and the second film FM2 may have a thickness equal to or greater than about 100 μm and equal to or smaller than about 200 μm. However, this is merely an example.

The thin film layer TG may include a glass material. However, it should not be limited thereto or thereby.

The thin film layer TG may have a thickness equal to or greater than about 1 μm and equal to or smaller than about 200 μm. The thickness of the thin film layer TG may be smaller than the thickness of the first film FM1 or the thickness of the second film FM2. The thin film layer TG may be used as a window for a display device. The thin film layer TG may be used as a window of a large-sized display device, such as a television set and a monitor, and a window of a small and medium-sized display device, such as a smart phone, a tablet computer, a car navigation unit, a game unit, etc. The thin film layer TG may be an ultra-thin glass (UTG), which is a material used as a display cover window.

Each of the first film FM1 and the second film FM2 may include polyethylene terephthalate, polyimide, or polymethyl methacrylate, however, this is merely an example, and the present disclosure should not be limited thereto or thereby.

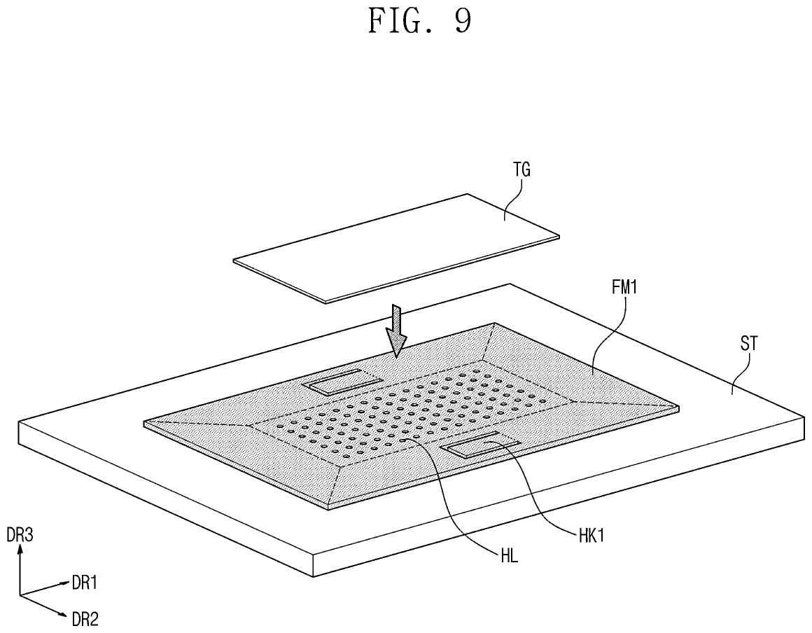

The first film FM1 may be provided with a plurality of holes HL defined therethrough to overlap the thin film layer TG in the plan view and to be spaced apart from each other. The holes HL may completely penetrate the first film FM1. Each of the holes HL may have a circular shape, however, this is merely an example. In the case where the holes HL are defined through the first film FM1 to overlap the thin film layer TG and to be spaced apart from each other in the plan view, the first film FM1 and the thin film layer TG may be stably adhered to each other and may not be separated from each other in the subsequent process. In detail, a stage ST (refer to FIG. 8) in which a plurality of grooves HM (refer to FIG. 8) is formed may be disposed under the first film FM1, at least a portion of air in the holes HL may be removed through the grooves HM (refer to FIG. 8), and thus, the first film FM1 and the thin film layer TG may be tightly adhered to each other due to an absorption force generated when the air is removed. As the holes HL are defined through the first film FM1, the adhesion between the first film FM1 and the thin film layer TG may be maintained without including an adhesive, and a process of applying an adhesive and a process of removing the adhesive may be omitted. As a result, the usability and convenience may be effectively improved in protecting the thin film layer TG.

Each of the holes HL may have a diameter equal to or greater than about 3 mm and equal to or smaller than about 5 mm, however, this is merely an example.

According to an embodiment, a separation distance between two holes HL adjacent to each other among the holes HL may be equal to or greater than about 3 mm and equal to or smaller than about 5 mm. The holes HL may be arranged such that the separation distance between any two holes HL adjacent to each other is substantially constant. In the case where the holes HL are arranged to allow the separation distance between any two adjacent holes HL to be substantially constant, the absorption force may be uniformly applied to the thin film layer TG through the holes HL, however, this is merely an example, and the present disclosure should not be limited thereto or thereby.

Each of the first film FM1 and the second film FM2 may have a rectangular shape. The first film FM1 may include a first-first film side FMS1-1 substantially parallel to the first direction DR1, a first-second film side FMS1-2 substantially parallel to the first direction DR1 and opposite to the first-first film side FMS1-1, a first-third film side FMS1-3 substantially parallel to the second direction DR2, and a first-fourth film side FMS1-4 substantially parallel to the second direction DR2 and opposite to the first-third film side FMS1-3. The second film FM2 may include a second-first film side FMS2-1 substantially parallel to the first direction DR1, a second-second film side FMS2-2 substantially parallel to the first direction DR1 and opposite to the second-first film side FMS2-1, a second-third film side FMS2-3 substantially parallel to the second direction DR2, and a second-fourth film side FMS2-4 substantially parallel to the second direction DR2 and opposite to the second-third film side FMS2-3.

A length in the first direction DR1 of the first-first film side FMS1-1 may be greater than a length in the second direction DR2 of the first-third film side FMS1-3. A length in the first direction DR1 of the first-second film side FMS1-2 may be greater than the length in the second direction DR2 of the first-third film side FMS1-3. The length in the first direction DR1 of the first-first film side FMS1-1 may be greater than a length in the second direction DR2 of the first-fourth film side FMS1-4. The length in the first direction DR1 of the first-second film side FMS1-2 may be greater than the length in the second direction DR2 of the first-fourth film side FMS1-4. The length in the first direction DR1 of each of the first-first film side FMS1-1 and the first-second film side FMS1-2 may be greater than the length in the second direction DR2 of each of the first-third film side FMS1-3 and the first-fourth film side FMS1-4.

A length in the first direction DR1 of the second-first film side FMS2-1 may be greater than a length in the second direction DR2 of the second-third film side FMS2-3. A length in the first direction DR1 of the second-second film side FMS2-2 may be greater than the length in the second direction DR2 of the second-third film side FMS2-3. The length in the first direction DR1 of the second-first film side FMS2-1 may be greater than a length in the second direction DR2 of the second-fourth film side FMS2-4. The length in the first direction DR1 of the second-second film side FMS2-2 may be greater than the length in the second direction DR2 of the second-fourth film side FMS2-4. The length in the first direction DR1 of each of the second-first film side FMS2-1 and the second-second film side FMS2-2 may be greater than the length in the second direction DR2 of each of the second-third film side FMS2-3 and the second-fourth film side FMS2-4.

The thin film layer TG may include a first thin film side TGS1 substantially parallel to the first-first film side FMS1-1, a second thin film side TGS2 substantially parallel to the first-second film side FMS1-2, a third thin film side TGS3 substantially parallel to the first-third film side FMS1-3, and a fourth thin film side TGS4 substantially parallel to the first-fourth film side FMS1-4. The second thin film side TGS2 may be opposite to the first thin film side TGS1, and the fourth thin film side TGS4 may be opposite to the third thin film side TGS3.

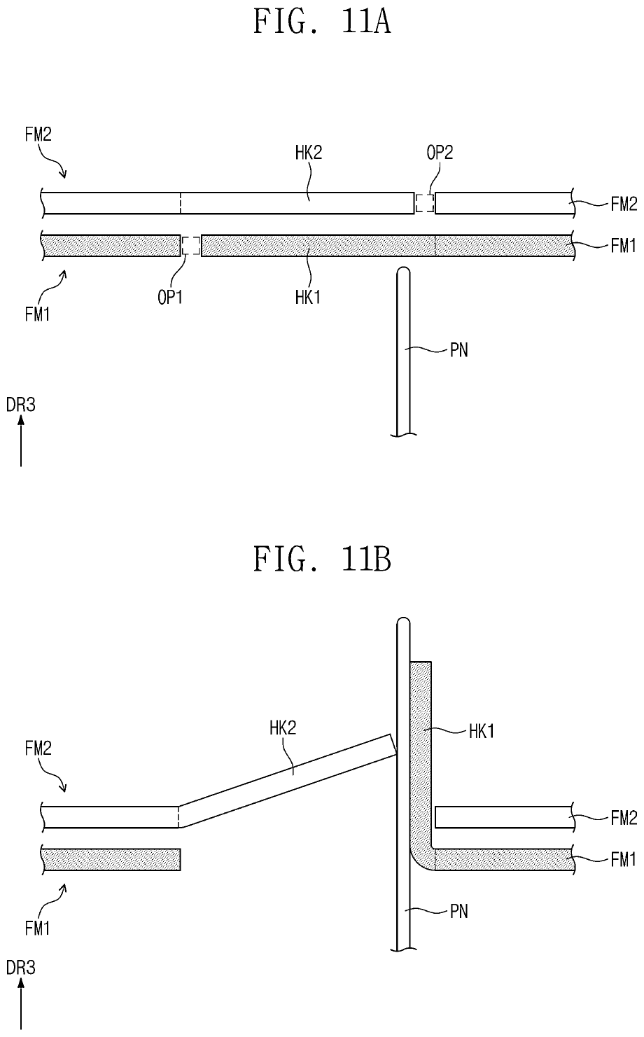

The first film FM1 may include a first-first film portion FMA1-1 adjacent to the first thin film side TGS1, a first-second film portion FMA1-2 adjacent to the second thin film side TGS2, a first-third film portion FMA1-3 adjacent to the third thin film side TGS3, a first-fourth film portion FMA1-4 adjacent to the fourth thin film side TGS4, and a first thin film cover portion FMU1 overlapping and corresponding to the thin film layer TG in a plan view (refer to FIG. 10). In other words, a boundary of the first thin film cover portion FMU1 may align with a boundary of the thin film layer TG in the plan view. The second film FM2 may include a second-first film portion FMA2-1 adjacent to the first thin film side TGS1, a second-second film portion FMA2-2 adjacent to the second thin film side TGS2, a second-third film portion FMA2-3 adjacent to the third thin film side TGS3, a second-fourth film portion FMA2-4 adjacent to the fourth thin film side TGS4, and a second thin film cover portion FMU2 overlapping and corresponding to the thin film layer TG in a plan view (refer to FIG. 4). In other words, a boundary of the second thin film cover portion FMU2 may align with a boundary of the thin film layer TG in the plan view.

The first thin film cover portion FMU1 may not overlap the first-first film portion FMA1-1, the first-second film portion FMA1-2, the first-third film portion FMA1-3, and the first-fourth film portion FMA1-4 in the plan view. The second thin film cover portion FMU2 may not overlap the second-first film portion FMA2-1, the second-second film portion FMA2-2, the second-third film portion FMA2-3, and the second-fourth film portion FMA2-4 in the plan view. The first hook portion HK1 may be disposed in one of the first-first film portion FMA1-1, the first-second film portion FMA1-2, the first-third film portion FMA1-3, and the first-fourth film portion FMA1-4. As an example, the first hook portion HK1 may be disposed at least one of the first-first film portion FMA1-1 and the first-second film portion FMA1-2, however, the present disclosure should not be limited thereto or thereby.

Each of the first hook portion HK1 and the second hook portion HK2 may have a rectangular shape, however, this is merely an example. The first hook portion HK1 may include a first-first hook side HKS1-1 extending in the first direction DR1, a first-second hook side HKS1-2 opposite to the first-first hook side HKS1-1 and extending in the first direction DR1, a first-third hook side HKS1-3 extending in the second direction DR2, and a first-fourth hook side HKS1-4 opposite to the first-third hook side HKS1-3 and extending in the second direction DR2. The first-first hook side HKS1-1 may have a length greater than a length of the first-third hook side HKS1-3. The first-second hook side HKS1-2 may have a length greater than the length of the first-third hook side HKS1-3. The length of the first-first hook side HKS1-1 may be greater than a length of the first-fourth hook side HKS1-4. The length of the first-second hook side HKS1-2 may be greater than the length of the first-fourth hook side HKS1-4. The second hook portion HK2 may include a second-first hook side HKS2-1 extending in the first direction DR1, a second-second hook side HKS2-2 opposite to the second-first hook side HKS2-1 and extending in the first direction DR1, a second-third hook side HKS2-3 extending in the second direction DR2, and a second-fourth hook side HKS2-4 opposite to the second-third hook side HKS2-3 and extending in the second direction DR2. The second-first hook side HKS2-1 may have a length greater than a length of the second-third hook side HKS2-3. The second-second hook side HKS2-2 may have a length greater than the length of the second-third hook side HKS2-3. The length of the second-first hook side HKS2-1 may be greater than a length of the second-fourth hook side HKS2-4. The length of the second-second hook side HKS2-2 may be greater than the length of the second-fourth hook side HKS2-4. In the case where the length of the first-first hook side HKS1-1 is greater than the length of the first-third hook side HKS1-3 and the length of the second-first hook side HKS2-1 is greater than the length of the second-third hook side HKS2-3, an area of the second hook portion HK2, which may be placed on the first hook portion HK1, of a total area of the second hook portion HK2 may increase, and thus, the first film FM1 may be adhered to the second film FM2 more easily.

The length of each of the first-first hook side HKS1-1, the first-second hook side HKS1-2, the second-first hook side HKS2-1, and the second-second hook side HKS2-2 may be equal to or greater than about 5 mm and equal to or smaller than about 20 mm. The length of each of the first-third hook side HKS1-3, the first-fourth hook side HKS1-4, the second-third hook side HKS2-3, and the second-fourth hook side HKS2-4 may be equal to or greater than about 3 mm and equal to or smaller than about 10 mm, however, this is merely an example, and the present disclosure should not be particularly limited.

The first film FM1 may be provided with a first opening OP1 that surrounds the first-first hook side HKS1-1, the first-second hook side HKS1-2, and the first-third hook side HKS1-3 and does not overlap the thin film layer TG in the plan view. The second film FM2 may be provided with a second opening OP2 that surrounds the second-first hook side HKS2-1, the second-second hook side HKS2-2, and the second-fourth hook side HKS2-4 and does not overlap the thin film layer TG in the plan view. The first opening OP1 and the second opening OP2 may completely penetrate the first film FM1 and the second film FM2, respectively. The first opening OP1 and the second opening OP2 may provide a space that allows the first hook portion HK1 and the second hook portion HK2 to be more easily bent in the third direction DR3 or a direction opposite to the third direction DR3 and may make at least a portion of the first hook portion HK1 easier to be disposed on the second hook portion HK2.

FIG. 3 is a cross-sectional view take along a line I-I′ of FIG. 1, and FIG. 4 is a cross-sectional view take along a line II-II′ of FIG. 1.

Referring to FIGS. 2 to 4, at least the portion of the first hook portion HK1 may be disposed on the second hook portion HK2. At least the portion of the first hook portion HK1 may be disposed directly on the second hook portion HK2. The first hook portion HK1 may be bent in the third direction DR3, and the second hook portion HK2 may be bent in the direction opposite to the third direction DR3.

The first-first film portion FMA1-1 may include a first-first contact portion TA1-1 that does not overlap the first hook portion HK1 in the plan view. The first-first contact portion TA1-1 may correspond to a portion of the first-first film portion FMA1-1 except the first hook portion HK1. The first-second film portion FMA1-2 may include a first-second contact portion TA1-2 that does not overlap the first hook portion HK1 in the plan view. The first-second contact portion TA1-2 may correspond to a portion of the first-second film portion FMA1-2 except the first hook portion HK1.

The second-first film portion FMA2-1 may include a second-first contact portion TA2-1 that does not overlap the second hook portion HK2 in the plan view. The second-first contact portion TA2-1 may correspond to a portion of the second-first film portion FMA2-1 except the second hook portion HK2. The second-second film portion FMA2-2 may include a second-second contact portion TA2-2 that does not overlap the second hook portion HK2 in the plan view. The second-second contact portion TA2-2 may correspond to a portion of the second-second film portion FMA2-2 except the second hook portion HK2.

At least a portion of the first-first contact portion TA1-1 may be in contact with the second-first contact portion TA2-1. At least a portion of the first-second contact portion TA1-2 may be in contact with the second-second contact portion TA2-2.

When the portion of the first hook portion HK1 is disposed on the second hook portion HK2 while the first hook portion HK1 is disposed in the first-first film portion FMA1-1 and the second hook portion HK2 is disposed in the second-first film portion FMA2-1, the first hook portion HK1 may be affected by a restoring force acting in the direction opposite to the third direction DR3, and the second hook portion HK2 may be affected by a restoring force acting in the third direction DR3. Due to the restoring force acting on the first hook portion HK1 and the second hook portion HK2, a distance between the first film FM1 and the second film FM2 may be reduced, and at least a portion of the first-first contact portion TA1-1 may be in contact with the second-first contact portion TA2-1. As at least the portion of the first-first contact portion TA1-1 is in contact with the second-first contact portion TA2-1, foreign substances may be prevented from entering the thin film layer TG in the second direction DR2.

When the portion of the first hook portion HK1 is disposed on the second hook portion HK2 while the first hook portion HK1 is disposed in the first-second film portion FMA1-2 and the second hook portion HK2 is disposed in the second-second film portion FMA2-2, the first hook portion HK1 may be affected by the restoring force acting in the direction opposite to the third direction DR3, and the second hook portion HK2 may be affected by the restoring force acting in the third direction DR3. Due to the restoring force acting on the first hook portion HK1 and the second hook portion HK2, the distance between the first film FM1 and the second film FM2 may be reduced, and at least a portion of the first-second contact portion TA1-2 may be in contact with the second-second contact portion TA2-2. As at least the portion of the first-second contact portion TA1-2 is in contact with the second-second contact portion TA2-2, foreign substances may be prevented from entering the thin film layer TG in the second direction DR2.

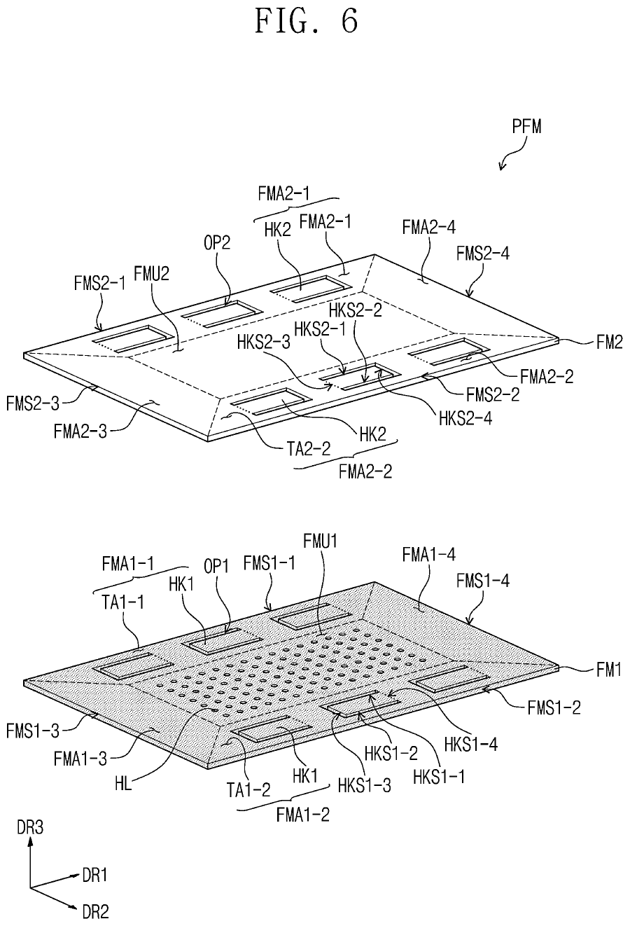

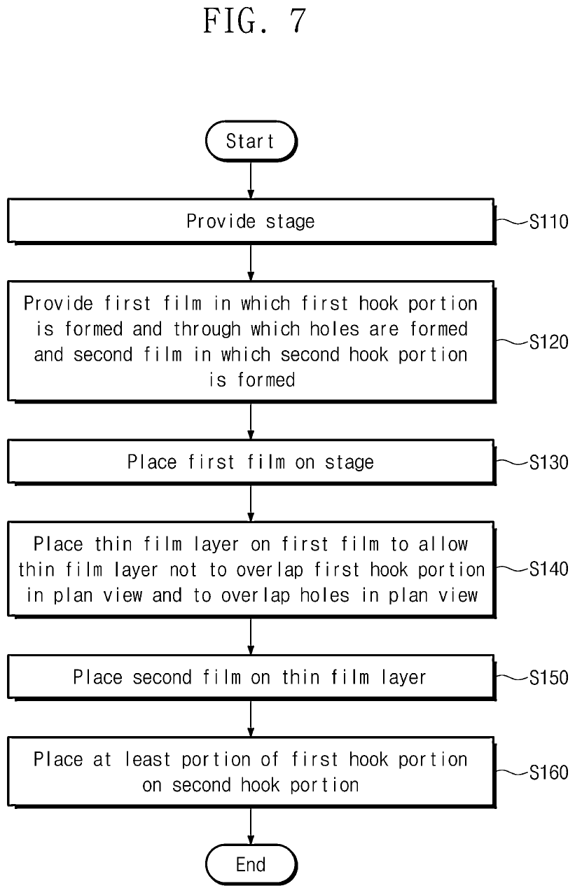

FIG. 5 is an exploded perspective view of some components of a protective film module according to an embodiment of the present disclosure. FIG. 6 is an exploded perspective view of some components of a protective film module according to an embodiment of the present disclosure. Meanwhile, for the convenience of explanation, FIGS. 5 and 6 show first and second films FM1 and FM2 of a protective film module, and a thin film layer TG is omitted.

Referring to FIG. 5, each of a first hook portion HK1 and a second hook portion HK2 may be provided in plural. Each of a first-first film portion FMA1-1, a first-second film portion FMA1-2, a first-third film portion FMA1-3, and a first-fourth film portion FMA1-4 may include the plural first hook portions HK1. The first-third film portion FMA1-3 may include a first-third contact portion TA1-3 that does not overlap the first hook portion HK1 in the plan view. The first-third contact portion TA1-3 may correspond to a portion of the first-third film portion FMA1-3 except the first hook portion HK1. The first-fourth film portion FMA1-4 may include a first-fourth contact portion TA1-4 that does not overlap the first hook portion HK1 in the plan view. The first-fourth contact portion TA1-4 may correspond to a portion of the first-fourth film portion FMA1-4 except the first hook portion HK1.

Each of a second-first film portion FMA2-1, a second-second film portion FMA2-2, a second-third film portion FMA2-3, and a second-fourth film portion FMA2-4 may include the plural second hook portions HK2. The second-third film portion FMA2-3 may include a second-third contact portion TA2-3 that does not overlap the second hook portion HK2 in the plan view. The second-third contact portion TA2-3 may correspond to a portion of the second-third film portion FMA2-3 except the second hook portion HK2. The second-fourth film portion FMA2-4 may include a second-fourth contact portion TA2-4 that does not overlap the second hook portion HK2 in the plan view. The second-fourth contact portion TA2-4 may correspond to a portion of the second-fourth film portion FMA2-4 except the second hook portion HK2.

The second hook portions HK2 may be arranged to correspond to the first hook portions HK1, respectively. As an example, the first-first film portion FMA1-1 may include three first hook portions HK1. The first-second film portion FMA1-2 may include three first hook portions HK1. The first-third film portion FMA1-3 may include two first hook portions HK1. The first-fourth film portion FMA1-4 may include two first hook portions HK1. The second-first film portion FMA2-1 may include three second hook portions HK2. The second-second film portion FMA2-2 may include three second hook portions HK2. The second-third film portion FMA2-3 may include two second hook portions HK2. The second-fourth film portion FMA2-4 may include two second hook portions HK2, however, this is merely an example, and the present disclosure should not be limited thereto or thereby.

As shown in FIG. 5, in the case where the protective film module PFM includes the plural first hook portions HK1 and the plural second hook portions HK2, at least a portion of each of a first-first contact portion TA1-1, a first-second contact portion TA1-2, a first-third contact portion TA1-3, and a first-fourth contact portion TA1-4 may be in contact with a corresponding contact portion of a second-first contact portion TA2-1, a second-second contact portion TA2-2, a second-third contact portion TA2-3, and a second-fourth contact portion TA2-4. In the case where at least the portion of each of the first-first contact portion TA1-1, the first-second contact portion TA1-2, the first-third contact portion TA1-3, and the first-fourth contact portion TA1-4 is in contact with the corresponding contact portion of the second-first contact portion TA2-1, the second-second contact portion TA2-2, the second-third contact portion TA2-3, and the second-fourth contact portion TA2-4, foreign substances may be effectively prevented from being in contact with a surface of the thin film layer TG (refer to FIG. 2). For a more detailed example, When the portion of the first hook portion HK1 is disposed on the second hook portion HK2 while the first hook portion HK1 is disposed in the first-third film portion FMA1-3 and the second hook portion HK2 is disposed in the second-third film portion FMA2-3, the first hook portion HK1 may be affected by the restoring force acting in the direction opposite to the third direction DR3, and the second hook portion HK2 may be affected by the restoring force acting in the third direction DR3. Due to the restoring force acting on the first hook portion HK1 and the second hook portion HK2, the distance between the first film FM1 and the second film FM2 may be reduced, and at least a portion of the first-third contact portion TA1-3 may be in contact with the second-third contact portion TA2-3. As at least the portion of the first-third contact portion TA1-3 is in contact with the second-third contact portion TA2-3, foreign substances may be prevented from entering the thin film layer TG in the first direction DR1.

When the portion of the first hook portion HK1 is disposed on the second hook portion HK2 while the first hook portion HK1 is disposed in the first-fourth film portion FMA1-4 and the second hook portion HK2 is disposed in the second-fourth film portion FMA2-4, the first hook portion HK1 may be affected by the restoring force acting in the direction opposite to the third direction DR3, and the second hook portion HK2 may be affected by the restoring force acting in the third direction DR3. Due to the restoring force acting on the first hook portion HK1 and the second hook portion HK2, the distance between the first film FM1 and the second film FM2 may be reduced, and at least a portion of the first-fourth contact portion TA1-4 may be in contact with the second-fourth contact portion TA2-4. As at least the portion of the first-fourth contact portion TA1-4 is in contact with the second-fourth contact portion TA2-4, foreign substances may be prevented from entering the thin film layer TG in the direction opposite to the first direction DR1.

Different from the embodiment of FIG. 5, FIG. 6 shows a structure in which each of a first-third film portion FMA1-3 and a first-fourth film portion FMA1-4 does not include a first hook portion HK1 and each of a second-third film portion FMA2-3 and a second-fourth film portion FMA2-4 does not include a second hook portion HK2.

Referring to FIG. 6, each of the first hook portion HK1 and the second hook portion HK2 may be provided in plural. Each of a first-first film portion FMA1-1 and a first-second film portion FMA1-2 may include the plural first hook portions HK1. Each of a second-first film portion FMA2-1 and a second-second film portion FMA2-2 may include the plural second hook portions HK2. The second hook portions HK2 may be arranged to correspond to the first hook portions HK1, respectively. As an example, the first-first film portion FMA1-1 may include three first hook portions HK1. The first-second film portion FMA1-2 may include three first hook portions HK1. The second-first film portion FMA2-1 may include three second hook portions HK2. The second-second film portion FMA2-2 may include three second hook portions HK2.

As shown in FIG. 6, in the case where the protective film module PFM includes the plural first hook portions HK1 and the plural second hook portions HK2, foreign substances may be prevented from being in contact with a surface of the thin film layer TG (refer to FIG. 2) may be improved. When compared with the embodiment shown in FIG. 5, the protective film module of FIG. 6 includes a smaller number of first and second hook portions HK1 and HK2, and thus, there is an economic advantage in the manufacturing process. In addition, the first film FM1 and the second film FM2 of FIG. 6 may be easily attached to or detached from each other when compared with the embodiment shown in FIG. 5.

Hereinafter, a method of manufacturing the protective film module PFM will be described.

The protective film module manufactured by the manufacturing method of the protective film module is the same as the above-described protective film module PFM, and thus, the same elements will be assigned with the same reference numerals and details of the same elements will be omitted.

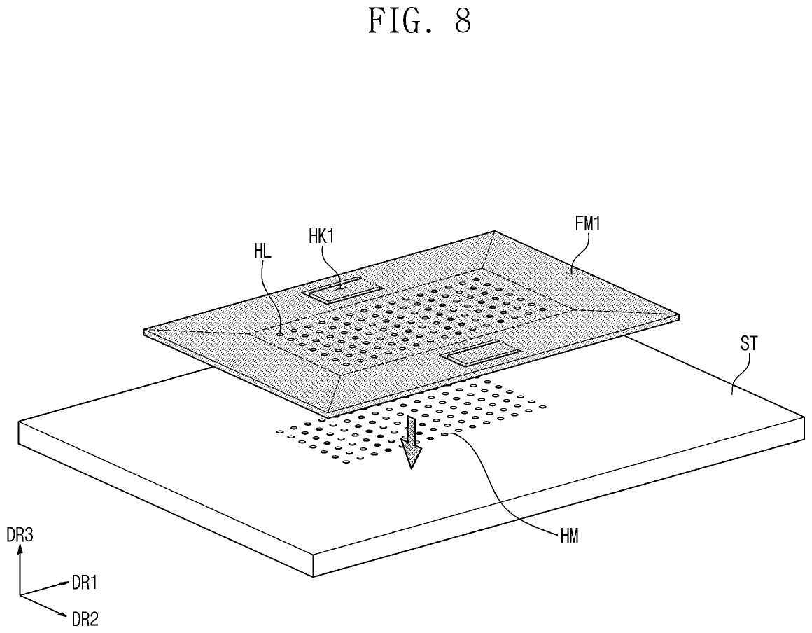

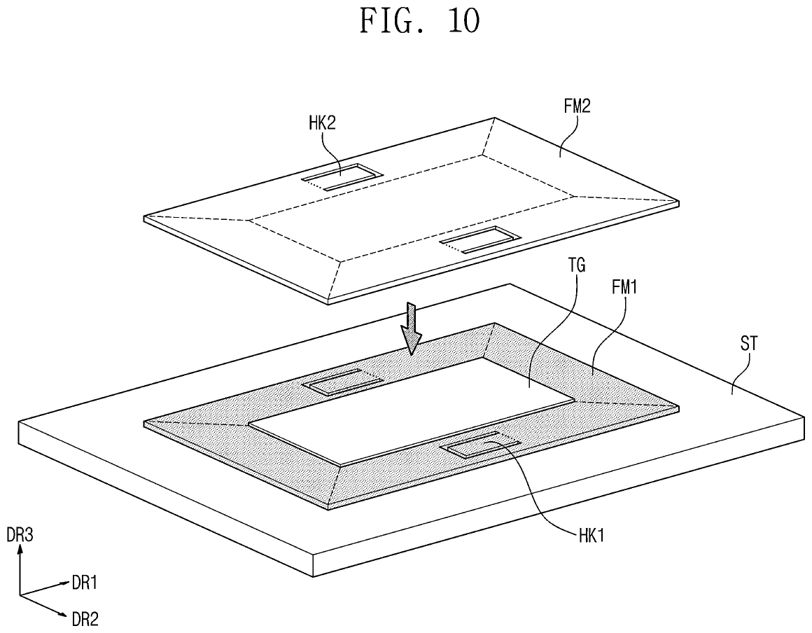

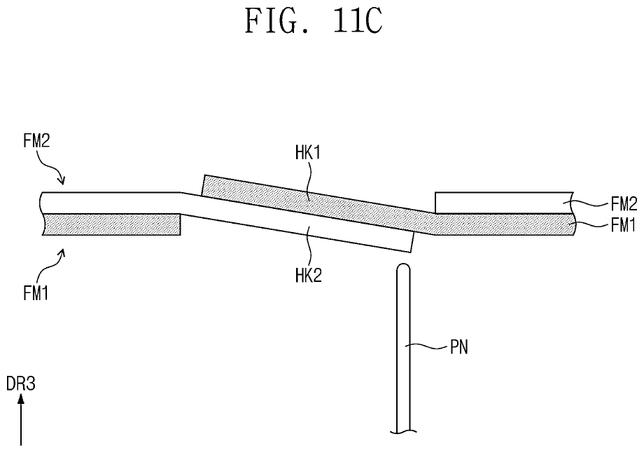

FIG. 7 is a flowchart illustrating a method of manufacturing the protective film module according to an embodiment of the present disclosure. FIG. 8 is a perspective view illustrating a process of the manufacturing method of the protective film module according to an embodiment of the present disclosure. FIG. 9 is a perspective view illustrating a process of the manufacturing method of the protective film module according to an embodiment of the present disclosure. FIG. 10 is a perspective view illustrating a process of the manufacturing method of the protective film module according to an embodiment of the present disclosure. FIGS. 11A, 11B, and 11C are cross-sectional views illustrating a process of engaging the first film to the second film of the manufacturing method of the protective film module according to an embodiment of the present disclosure.

Referring to FIGS. 7 and 8, the manufacturing method of the protective film module PFM may include providing the stage ST (S110), providing the first film FM1 in which the first hook portion HK1 is formed and through which the holes HL are formed and the second film FM2 in which the second hook portion HK2 is formed (S120), and placing the first film FM1 on the stage ST (S130).

The providing of the first film FM1 in which the first hook portion HK1 is formed and through which the holes HL are formed and the second film FM2 in which the second hook portion HK2 is formed (S120) may include forming the first hook portion HK1 and the holes HL and forming the second hook portion HK2. Referring to FIGS. 2 and 8, the first opening OP1 may be formed through a preliminary first film having a plate shape to surround the first-first hook side HKS1-1, the first-second hook side HKS1-2, and the first-third hook side HKS1-3. The holes HL may be formed through the preliminary first film provided with the first opening OP1 defined therethrough, and thus, the first film FM1 may be completed. The second film FM2 including the second hook portion HK2 may be formed by forming the second opening OP2 through a preliminary second film having a plate shape to surround the second-first hook side HKS2-1, the second-second hook side HKS2-2, and the second-fourth hook side HKS2-4. The holes HL may completely penetrate through the first film FM1. The first opening OP1 may completely penetrate the first film FM1. The second opening OP2 may completely penetrate the second film FM2. The first opening OP1 and the second opening OP2 may provide the space to facilitate the bending of each of the first hook portion HK1 and the second hook portion HK2 in the third direction DR3 or the direction opposite to the third direction DR3, and may allow at least the portion of the first hook portion HK1 to be easily disposed on the second hook portion HK2. As the first film FM1 includes the holes HL, the adhesion between the first film FM1 and the thin film layer TG (refer to FIG. 2) may be maintained without including adhesive, and a process of applying the adhesive and removing the adhesive may be omitted. As a result, the usability and convenience may be effectively improved in protecting the thin film layer TG (refer to FIG. 2).

Referring to FIG. 8, the stage ST may include the grooves HM corresponding to the holes HL, respectively. At least the portion of air in the holes HL may be removed through the grooves HM, and thus, the first film FM1 and the thin film layer TG (refer to FIG. 9) may be tightly adhered to each other.

The first film FM1 may be disposed on the stage ST such that the holes HL respectively correspond to the grooves HM.

Referring to FIGS. 7 and 9, the manufacturing method of the protective film module PFM may include placing the thin film layer TG on the first film FM1 to allow the thin film layer TG not to overlap the first hook portion HK1 in the plan view and to overlap the holes HL in the plan view (S140).

The thin film layer TG may be disposed on the first film FM1 to overlap the first thin film cover portion FMU1 (refer to FIG. 2) in the plan view.

Referring to FIGS. 7 and 10, the manufacturing method of the protective film module PFM may include placing the second film FM2 on the thin film layer TG (S150).

The second film FM2 may be disposed on the thin film layer TG to allow the second thin film cover portion FMU2 (refer to FIG. 2) to correspond to the upper surface of the thin film layer TG. The second hook portion HK2 may not overlap the thin film layer TG in the plan view.

Referring to FIGS. 7, 11A, 11B, and 11C, the manufacturing method of the protective film module PFM may include placing at least the portion of the first hook portion HK1 on the second hook portion HK2 using a pin PN (S160). The placing of at least the portion of the first hook portion HK1 on the second hook portion HK2 using the pin PN (S160) may include placing the pin PN on a lower surface of the first film FM1, moving the pin PN in the third direction DR3, and moving the pin PN in the direction opposite to the third direction DR3 to remove the pin PN.

Referring to FIGS. 11A and 11B, the pin PN may be disposed on the lower surface of the first film FM1. One end of the pin PN may be disposed adjacent to the second opening OP2. Then, the pin PN may move in the third direction DR3 to allow the first hook portion HK1 and the second hook portion HK2 to be bent in the third direction DR3. When the one end of the pin PN is disposed adjacent to the second opening OP2, a degree to which the first hook portion HK1 is bent in the third direction DR3 may be greater than a degree to which the second hook portion HK2 is bent in the third direction DR3 in the process of moving the pin PN in the third direction DR3.

Referring to FIG. 11C, the manufacturing method of the protective film module may include the moving of the pin PN in the direction opposite to the third direction DR3 to remove the pin PN. When the pin PN moves in the direction opposite to the third direction DR3, at least the portion of the first hook portion HK1 may be disposed on the second hook portion HK2. When at least the portion of the first hook portion HK1 is disposed on the second hook portion HK2, the first film FM1 and the second film FM2 may be close to each other, and when the portion of the first hook portion HK1 is disposed on the second hook portion HK2 as described with reference to FIG. 4, the first hook portion HK1 may be affected by the restoring force acting in the direction opposite to the third direction DR3, and the second hook portion HK2 may be affected by the restoring force acting in the third direction DR3. Due to the restoring force acting on the first hook portion HK1 and the second hook portion HK2, the distance between the first film FM1 and the second film FM2 may be reduced, and at least the portion of the first film FM1 may be in contact with the second film FM2. As at least the portion of the first film FM1 is in contact with the second film FM2, foreign substances may be prevented from entering the thin film layer TG (refer to FIG. 10) in a horizontal direction such as the second direction DR2 (refer to FIG. 1) and from being in contact with the surface of the thin film layer TG.

Although the embodiments of the present disclosure have been described, it is understood that the present disclosure should not be limited to these embodiments but various changes and modifications can be made by one ordinary skilled in the art within the spirit and scope of the present disclosure as hereinafter claimed. Therefore, the disclosed subject matter should not be limited to any single embodiment described herein, and the scope of the present invention shall be determined according to the attached claims.

What is claimed is:

1. A protective film module comprising:
a first film;
a second film disposed on the first film; and
a thin film layer disposed between the first film and the second film,
wherein the first film comprises a first hook portion, which is spaced apart from the thin film layer in a plan view, the second film comprises a second hook portion, which is spaced apart from the thin film layer in the plan view, and at least a portion of the first hook portion is disposed on the second hook portion.

2. The protective film module of claim 1, wherein each of the first film and the second film has a size greater than a size of the thin film layer in the plan view.

3. The protective film module of claim 1, wherein the first film has a same size as the second film in the plan view.

4. The protective film module of claim 1, wherein the thin film layer is disposed directly on the first film, and the second film is disposed directly on the thin film layer.

5. The protective film module of claim 1, wherein each of the first film and the second film has a thickness equal to or greater than about 100 micrometers and equal to or smaller than about 200 micrometers.

6. The protective film module of claim 1, wherein the thin film layer comprises a glass material.

7. The protective film module of claim 1, wherein each of the first film and the second film comprises polyethylene terephthalate, polyimide, or polymethyl methacrylate.

8. The protective film module of claim 1, wherein the first film is provided with a plurality of holes defined therethrough, overlapping the thin film layer in the plan view, and spaced apart from each other.

9. The protective film module of claim 8, wherein each of the holes has a diameter equal to or greater than about 3 millimeters (mm) and equal to or smaller than about 5 mm.

10. The protective film module of claim 8, wherein a distance between two holes adjacent to each other among the holes is equal to or greater than about 3 mm and equal to or smaller than about 5 mm.

11. The protective film module of claim 1, wherein each of the first film and the second film has a rectangular shape,
the first film comprises a first-first film side parallel to a first direction, a first-second film side parallel to the first direction and opposite to the first-first film side, a first-third film side parallel to a second direction intersecting the first direction, and a first-fourth film side parallel to the second direction and opposite to the first-third film side,
the second film comprises a second-first film side parallel to the first direction, a second-second film side parallel to the first direction and opposite to the second-first film side, a second-third film side parallel to the second direction, and a second-fourth film side parallel to the second direction and opposite to the second-third film side,
a length in the first direction of the first-first film side is greater than a length in the second direction of the first-third film side, and a length in the first direction of the second-first film side is greater than a length in the second direction of the second-third film side.

12. The protective film module of claim 11, wherein the thin film layer comprises a first thin film side parallel to the first-first film side, a second thin film side parallel to the first-second film side, a third thin film side parallel to the first-third film side, and a fourth thin film side parallel to the first-fourth film side,
the first film further comprises a first-first film portion adjacent to the first thin film side, a first-second film portion adjacent to the second thin film side, a first-third film portion adjacent to the third thin film side, a first-fourth film portion adjacent to the fourth thin film side, and a first thin film cover portion overlapping and corresponding to the thin film layer in the plan view,
the second film further comprises a second-first film portion comprising the second-first film side, a second-second film portion comprising the second-second film side, a second-third film portion comprising the second-third film side, a second-fourth film portion comprising the second-fourth film side, and a second thin film cover portion overlapping and corresponding to the thin film layer in the plan view, and
the first hook portion is disposed in at least one of the first-first film portion, the first-second film portion, the first-third film portion, and the first-fourth film portion.

13. The protective film module of claim 12, wherein each of the first hook portion and the second hook portion is provided in plural, and the first hook portions are disposed in the first-first film portion, the first-second film portion, the first-third film portion, and the first-fourth film portion, respectively.

14. The protective film module of claim 12, wherein each of the first hook portion and the second hook portion is provided in plural, and the first hook portions are disposed in the first-first film portion and the first-second film portion and are not disposed in the first-third film portion and the first-fourth film portion.

15. The protective film module of claim 12, wherein the first-first film portion comprises a first-first contact portion, which does not overlap the first hook portion in the plan view, the second-first film portion comprises a second-first contact portion, which does not overlap the second hook portion in the plan view, and at least a portion of the first-first contact portion is in contact with the second-first contact portion.

16. The protective film module of claim 1, wherein each of the first hook portion and the second hook portion has a rectangular shape, the first hook portion comprises a first-first hook side extending in a first direction, a first-second hook side opposite to the first-first hook side and extending in the first direction, a first-third hook side extending in a second direction intersecting the first direction, and a first-fourth hook side opposite to the first-third hook side and extending in the second direction, the second hook portion comprises a second-first hook side extending in the first direction, a second-second hook side opposite to the second-first hook side and extending in the first direction, a second-third hook side extending in the second direction, and a second-fourth hook side opposite to the second-third hook side and extending in the second direction, the first-first hook side has a length in the first direction greater than a length in the second direction of the first-third hook side, and the second-first hook side has a length in the first direction greater than a length in the second direction of the second-third hook side.

17. The protective film module of claim 16, wherein each of the length of the first-first hook side, a length in the first direction of the first-second hook side, the length of the second-first hook side, and a length in the second direction of the second-second hook side is equal to or greater than about 5 mm and equal to or smaller than about 20 mm, and each of the length of the first-third hook side, a length in the first direction of the first-fourth hook side, the length of the second-third hook side, and a length in the second direction of the second-fourth hook side is equal to or greater than about 3 mm and equal to or smaller than about 10 mm.

18. The protective film module of claim 16, wherein the first film is provided with a first opening, which surrounds the first-first hook side, the first-second hook side, and the first-third hook side and is spaced apart from the thin film layer in the plan view, and the second film is provided with a second opening, which surrounds the second-first hook side, the second-second hook side, and the second-fourth hook side and is spaced apart from the thin film layer in the plan view.

19. A method of manufacturing a protective film module, comprising:
providing a stage;
providing a first film in which a first hook portion is formed and through which holes are formed and a second film in which a second hook portion is formed;
placing the first film on the stage;
placing a thin film layer on the first film not to overlap the first hook portion in a plan view and to overlap the holes in the plan view;
placing the second film on the thin film layer, and
placing at least a portion of the first hook portion on the second hook portion.

20. The method of claim 19, wherein each of the first hook portion and the second hook portion is provided in plural.
